(19) United States
(12) Patent Application Publication
(10) Pub. No.: US 2001/0011805 A1
(43) Pub. Date: Aug. 9, 2001

(54) WHEELCHAIR WITH A FRONT WHEEL SUPPORT , WHEELCHAIR WITH AN ADJUSTABLY INCLINED SEAT, WHEELCHAIR WITH VARIABLY INCLINED REAR WHEEL AXLES, SEAT MODULES FOR A WHEELCHAIR, USE OF THE SEAT MODULE AND USE OF THE WHEELCHAIR

(76) Inventor: RAINER KUESCHALL, ALLSCHWILL (CH)

Correspondence Address: TOWNSEND AND TOWNSEND AND CREW, TWO EMBARCADERO CENTER 8TH FLOOR, SAN FRANCISCO, CA, 941113834

(21) Appl. No.: 09/104,694

(22) Filed: Jun. 25, 1998

(30) Foreign Application Priority Data
Jun. 25, 1997 (CH) 19971541/97

(51) Int. Cl. B62M 1/14

(52) U.S. Cl. 280/250.1; 280/304.1; 280/650

(57) ABSTRACT

A wheelchair (10), preferably with three wheels (18, 24), with a front wheel support (12.1) embodied as a transverse support. The front wheel support (12.1), together with two inclined supports (12.2), which adjoin its ends and are oriented backward and upward, forms a U-like integral support, which is connected with an axle tube (14) of the rear wheels (18). A wheelchair (10) with a seat (52), which has adjustably inclined lateral longitudinal seat supports (56). The longitudinal seat supports (56) are connected with longitudinal supports (12.3), which are inclined rearward and downward, of the frame of the wheelchair (10) indirectly by their front ends, and connected by their rear ends via seat struts (72) with adjustable effective strut length with said longitudinal supports (12.3). A wheelchair with an adjustable inclination of the rear wheel axles, wherein the rear wheel axles, which are embodied as full floating axles, are received in end areas of a rear axle tube (14), namely in angle adapter sleeves (22). These angle adapter sleeves comprise a section with a bore (22.2, 122.2) for receiving the full floating axles and an area (22.3, 122.3) with a detent surface, which extends obliquely in respect to the axes of these bores (22.2, 122.2). The angle adapter sleeves (22) are received in a longitudinally adjustable manner in the end areas of the axle tube (14.1, 14). A fixation device (22.7, 22.8) is provided in order to fix each angle adapter sleeve (22) selectively in place in one of several positions. A seat module (50) for a wheelchair (10), comprising a seat (52), which can be fastened on the frame (12.3) of the wheelchair (10), and a backrest (54), which is fastened on the seat (52), but cannot be fastened to the frame (12.3) of the wheelchair (10), and use of the seat module (50) in connection with a wheelchair (10). Use of a wheelchair (10) with a bike, wherein the wheel base of the wheelchair (10) is changed to prevent it from tilting backward in that the rear wheels (18) are moved from their customary position into a position which is further toward the rear.

### BACKGROUND OF THE INVENTION

Conventional wheelchairs have two pairs of wheels, namely a rear wheel pair with two large, manually drivable rear wheels, and a front wheel pair with two considerably smaller front wheels laterally arranged on the wheelchair, whose axles can turn in a horizontal plane around a center of rotation. The wheelchairs constructed in accordance with this principle cannot be maneuvered particularly well, which is a great disadvantage, in particular in connection with sport wheelchairs. The maneuverability of wheelchairs can be considerably improved, if the wheels of the front pair of wheels are arranged centered at a small distance from each other or if, which is even more advantageous, there is only a single front wheel. Therefore three-wheeled wheelchairs with a rear pair of wheels and a single, centered front wheel have been offered for some time as sport wheelchairs.

For example, a three-wheeled sport wheelchair of the Sopur company is known, which has a frame with a rear axle tube connecting the axles of the rear wheels, from which a centered, approximately horizontal longitudinal support extends forward. Two plates are arranged as a footrest at the front of this longitudinal support, and the front wheel is arranged ahead of the footrest, i.e. at the very front of the longitudinal support. In addition, a further longitudinal support is arranged on the longitudinal support between the axle tube and the front wheel, which is oriented obliquely backward and upward and is forked under the seating surface to form a transverse support. Lateral seat tubes extending in the longitudinal direction are fastened on the transverse support. A disadvantage of this wheelchair is its partial lack of lateral stability, which can be traced back to the specific frame construction.

Another three-wheeled sport wheelchair of the Off.Car company, namely the Top Spin model, is slightly improved in respect to frame stability since, in place of the obliquely backward and upward oriented longitudinal support of the above described wheelchair, it has two supports starting at the fastening place of the front wheel, which are oriented obliquely upward and outward in the approximate shape of a V, whose free ends are bent underneath the seating surface and form longitudinal supports extending obliquely backward and downward, on which a seat is mounted. Additional struts connect the lateral longitudinal supports with the centered, horizontal longitudinal support and with the axle tube, and these additional struts are also connected with each other. As already mentioned, although the frame of this wheelchair is slightly more stable than the frame of the first-mentioned wheelchair, it has the disadvantage of a very complicated, elaborate construction.

### OBJECT AND SUMMARY OF THE INVENTION

It is therefore the object of the invention to create an easily maneuverable wheelchair of the type mentioned at the outset, which does not have the listed disadvantages and is particularly suitable for everyday use.

This object is attained by the invention by means of the features of the characterizing portion of claim 1. Advantageous further developments are defined in the corresponding dependent claims 2 to 5.

There is the general desire to adjust various elements of a wheelchair in relation to each other in order to adapt the wheelchair to different users and/or momentary requirements. The inclination of the seat in particular should be adjustable. Although several wheelchairs are known, where the inclination of the seat can be changed, they have the disadvantage that adjustments of the seat cannot be performed independently of other elements. For example, a change in the inclination of the seat generally requires the remounting of certain other elements of the wheelchair.

It is therefore also an object of the invention to create a wheelchair with an adjustably inclined seat, wherein the mentioned disadvantage does not occur, so that a change of the seating angle is possible without additional remounting, setting and adjustment steps.

The features of the characterizing portion of claim 6 are used to attain this object. Preferably employed further developments of this wheelchair of the invention are defined by claims 7 and 8, which depend from claim 6.

Many of the wheelchairs in use today have rear wheels with wheel camber, i.e. the rear wheels are not located in vertical planes, but in symmetrical planes, which are outwardly and downwardly inclined in respect to the longitudinal center plane. To adapt a wheelchair to different users or prevailing exterior conditions it is advantageous if the inclination of these axles can be selectively adjusted.

It is therefore furthermore the object of the invention to create a wheelchair with adjustably inclined rear wheel axles.

This is attained in a wheelchair having the features of the characterizing portion of claim 9.

To adapt a wheelchair to different users, it is in particular necessary to design it in such a way that it contains a seat module, which can be mounted, or respectively removed, in a simple way, and which itself has certain adjustment possibilities.

It is therefore also an object of the invention to create a suitable seat module.

This object is attained by the invention by means of the features of the characterizing portion of claim 10. Preferred further developments and details of the seat module of the invention are defined in claims 11 to 18, which depend from claim 10.

The use of the novel seat module in a wheelchair is a further object of the invention.

In accordance with the invention, this object is attained by means of the features of the characterizing portion of claim 19. Advantageous details are defined by claim 20, which depends from claim 19.

Lately wheelchairs have been designed in such a way, that they can be used in conjunction with a so-called bike. A bike is a device with a front wheel, a drive and steering. The wheelchair is attached to the bike and, together with the bike, constitutes a unit which can be driven by a motor. This unit runs on three wheels, namely the wheel of the bike, which constitutes a driving wheel arranged at the front, and the rear wheels of the wheelchair, which form running wheel arranged in the rear. When connecting the wheelchair, it is slightly tilted back, so that its front wheel, or respectively front wheels, are no longer in contact with the ground. This arrangement has a grave disadvantage, namely the tendency of the wheelchair, and therefore of the unit, to tilt backward.

It is therefore a final object of the invention to suggest steps for using this wheelchair in connection with a bike, wherein the mentioned disadvantage can be avoided.

In accordance with the invention, this object is attained by means of the features of the characterizing portion of claim 21. Particularly advantageous options for its use in accordance with the invention are defined by claims 22 to 24, which depend from claim 21.

The wheelchair in accordance with the invention with a front wheel support has a very simple, U-like, but three-dimensional integral support, whose free ends are connected with the axle tube, by means of which a closed, and therefore very stable frame is created. The U-like integral support is shaped in such a way that the center leg of the U is a transverse support, which constitutes the front wheel support for fastening the front wheel assembly, that the adjoining portions of the lateral legs of the U are oriented approximately vertically and approximately parallel with the longitudinal center plane of the wheelchair and form the ends of free legs of the longitudinal U support, or respectively are arranged at least approximately parallel with the movement direction. The riding behavior of the novel wheelchair is very comfortable and easy because of this frame construction, which generates a spring effect, so that it conveys the feeling to the user of practically flying over uneven ground.

In order to obtain a wheelchair with the best possible maneuverability, a front wheel assembly with a single central front wheel is used. Compared with the present four-wheeled wheelchairs, the fourth wheel with the suspension of the fork is saved, which has an advantageous effect on weight and cost.

Although it had originally been the aim of the invention to create a wheelchair with a front wheel assembly containing a single central front wheel, the novel wheelchair with the three-dimensional integral support can also be used for front wheel assemblies with two front wheels. If the front wheels are arranged at the minimal distance required for their rotatability, the result is a wheelchair which still is quite easily maneuverable, but is slightly more tilt-proof than a wheelchair with only one front wheel. Increasing the distance between the front wheels worsens maneuverability, but at the same time increases the lateral tilt stability. To selectively increase or decrease the distance between the front wheels, the front wheel fastening of each wheel can be designed to be such that it can be displaced along the front wheel support and fastened at any arbitrary location.

The base of those wheelchairs in particular, where the front wheel assembly contains only a single front wheel or two front wheels mounted very close to each other, is basically narrower than that of a conventional wheelchair with two front wheels mounted on the side. In order to obtain the largest possible base in spite of this, and therefore great tilting stability, it is advantageous to arrange the front wheel in such a way that it constitutes the frontmost element of the wheelchair. To this end the front wheel fastening is not arranged under or behind, but in front of the front wheel support. Because of the arrangement of the footrest behind the front wheel support, the novel wheelchair is considerably easier to turn in use, since the mass of the feet and legs of the user is located closer to the total center of gravity.

The arrangement of the front wheel fastening at the front of the front wheel support provides a further advantage. The space behind the front wheel support is free and offers itself for a continuous comfortable footrest, which is not divided by longitudinally oriented front wheel supports. As a result of the design of the front wheel support as a transverse support and because of its arrangement in front of the footrest, the front wheel support simultaneously forms a protection for the footrest, or respectively the feet of the user resting on the footrest. This has an advantageous effect, since most users no longer have nerves, and therefore no feeling of pain, in the area of the feet and legs because of their illness, so that in case of large injuries, which could occur if the feet strike against something during the forward movement of the wheelchair, no warning pain is felt.

The position of the footrest is preferably selectable, namely both in respect to its height and in respect to its angle of inclination. To this end, the footrest can be fastened on foot struts which are mounted on the inclined supports and whose size and mounting height determine the distance of the footrest from the transverse support and the height of the foot rest. Depending on the requirements, it is possible to choose the most suitable among the foot struts of different dimensions, or always the same foot struts can be mounted at different heights. For example, for adjusting the angle of inclination of the foot rest, the foot struts can be designed tube-like and bent downward toward the longitudinal axis of the wheelchair. These ends are received between two legs of a shackle device, which can be clamped together by means of screws.

In place of the plate-shaped footrest described above it is also possible to provide a stirrup-shaped footrest.

The wheelchair has a brake device acting on the rear wheels, which preferably consists of two basically equal brake units, which are designed diametrically opposed and mounted mirror-reversed in respect to the longitudinal wheelchair axis on the seat supports.

A seat of the wheelchair is fastened on the longitudinal supports of the integral support of the wheelchair. The longitudinal supports can be inclined to a greater or lesser extent, depending on the desired inclination of the seat.

It is particularly advantageous if the longitudinal supports extend at such an inclination toward the back that they directly meet the ends of the axle tube. Additional connecting struts, which connect the integral support with the axle tube to form a closed frame, can be omitted because of this.

Since, as mentioned further on above, an adjustment of the seat inclination of conventional wheelchairs with longitudinal seat supports fastened on longitudinal supports at seat height requires additional adjustment work, the adjustably inclined seat of the wheelchair in accordance with the invention can be adjusted in such a way that no additional mounting effort is required. To this end the wheelchair has a longitudinal support oriented toward the rear and downward. The longitudinal seat supports are fastened on these inclined longitudinal supports in such a way that in front they are pivotable around a point of the longitudinal supports and in the rear they have an adjustable distance from the longitudinal supports. A seat strut arrangement is disposed for this purpose which has two seat struts, each of which is pivotably fastened at a pivot point on one of the longitudinal seat supports and is fastened with a selectable effective seat strut length on the longitudinal support of the integral support. Thus, the longitudinal support, the longitudinal seat support and the seat strut respectively form a triangle in a vertical plane underneath the seat. The maximum inclination toward the rear and downward which the seat can take is determined by the inclination of the longitudinal supports of the integral support, and the maximum inclination toward the front and downward which the seat can take is determined by the length of the seat struts.

Although it is possible to use longitudinally adjustable seat struts, possibly with fluid-actuated cylinder/piston arrangements or with spindles, a simple embodiment of the wheelchair in accordance with the invention is designed in such a way that the longitudinal struts have a plurality of bores over their length. Depending on the selected seat inclination, two screws are passed through two bores which are located at equal distances from the pivot points, by means of which the seat struts are fastened to the associated longitudinal supports.

It has been found advantageous for the purpose of stabilization to place the two seat struts parallel with each other by means of a transverse rod arrangement.

The longitudinal seat supports can be fastened on two individual longitudinal supports of the frame of the wheelchair. However, it is particularly advantageous to mount them on two longitudinal supports of an integral support of a wheelchair in accordance with the above description.

Several possible fastening points are preferably provided in the longitudinal direction at the front ends of the longitudinal support of the integral support.

The bearings for the rear wheels are located in the rear wheel hub and are designed in such a way that the rear wheels can be mounted in a known manner by means of full floating axles in angle adapter sleeves and in this way can be easily removed.

In the mounted state, the angle adapter sleeves for the axles of the rear wheels are generally designed as full floating axles, are oriented transversely to the movement direction and laterally slightly upward, so that the wheels are arranged with a defined wheel camber, as is customary in connection with wheelchairs. In order to set the parallel tracking of the rear wheels exactly, the axle tube with the angle adapter sleeves arranged therein can be rotated until it takes up the position in which the angle adapter sleeves are correctly oriented, i.e. its correct position. A spirit level can be installed on the axle tube for this purpose.

The inclination of the rear axles is adjustable in accordance with the invention, so that the angular wheel camber can be changed. On the one hand, this wheel camber is determined by the dimensions of the wheelchair, and on the other hand by the respective purpose of employment of the wheelchair. Angularly fixed angle adapter sleeves, which are pushed into the axle tube and contain the angle adapter sleeves for the axles of the rear wheels, can be respectively exchanged in pairs for changing the wheel camber. However, the installation of a pair of adjustable angle adapter sleeves is more advantageous. By means of such adjustable angle adapter sleeves it is possible to change the wheel camber in an approximate range between 0° and approximately 25°.

The seat module in accordance with the invention includes the actual seat and a backrest, which is fastened on the seat and therefore only indirectly on the frame of the wheelchair. The seat has two longitudinal seat supports, which can be fastened to the frame of the wheelchair and between which the seating surface extends.

To increase their stability, the longitudinal seat supports are preferably connected by at least one transverse seat support, and in a particularly suitable embodiment the longitudinal seat supports and a transverse seat support, which is arranged in the rear, form a U-shaped seat frame, which can be reinforced by a further seat reinforcement support provided in its front area and curved downward.

With so-called foldable wheelchairs, wherein folding causes a reduction of the wheelchair width, the transverse seat supports consist of two partial transverse seat supports, which are hingedly connected with each other and can be folded together, but which are fixed in place in a linearly aligned arrangement in the ready-to-use state of the wheelchair. In connection with such wheelchairs the actual seating surface also must be designed in such a way that it allows folding of the wheelchair. The transverse seat supports of fixed-width wheelchairs are rigid.

If, in spite of the option of folding down the backrest described further down below, the wheelchair is not an actual foldable wheelchair, which can be folded together to reduce its width, the seating surface could be rigid. However, even with such fixed-width wheelchairs, a flexible material, such as a fabric section, is used for the seating surface, on which a replaceable seat cushion is generally placed. A seat cushion designed in a wedge shape makes it possible to affect the inclination of the seat further.

As already mentioned, the novel seat module includes the just described seat as well as a backrest fastened on the seat without being directly connected with the frame of the wheelchair. In a preferred embodiment of the seat module in accordance with the invention, the backrest has two lateral, often tube-shaped backrest supports, whose lower ends are fastened by means of angle plates to the rear area of the longitudinal seat supports. It is possible to achieve a certain amount of adjustability in that different bores, either in the angle plates and/or in the longitudinal seat supports and/or in the backrest supports are provided for fastening the angle plates.

If it is intended to fold the backrest down on the seat for reducing the transport volume of the wheelchair, the angle plates are fastened in such a way that they can rotate around their two fastening axes on the longitudinal seat support and on the backrest. However, in order to fix the backrest in place in relation to the seat in spite of this when the wheelchair is in use, two lateral fixation plates are provided, which are rigidly fastened on the longitudinal seat supports and contain slit-shaped openings, through which pins of the backrest protrude. When the backrest has not been folded on the seat, the fixation plates form angular struts between the longitudinal seat supports and the backrests. On their rear ends the openings have detent openings for the pins, which extend transversely and are oriented upward when the backrest is not folded down. The slightly resilient fixation plates are connected at their rear ends by a string. Pulling up on the string causes the pins to disengage from the detent openings and permits the backrest to be folded down on the seat. The fixation plates are fastened by means of screws on the longitudinal seat supports To allow a selective fastening in different positions, they can have several adjoining bores for the screws in place of a single bore.

The fixation plates can also be used for fastening lateral clothing protector plates, which can be screwed to the fixation plates, or for fastening a wheel splatter protector. The wheel splatter protector is preferably designed in such a way that it has a slightly resilient wheel protector shackle, which can be mounted in different positions, on the side facing away from the user, so that the wheel splatter protector can be pushed without the use of tools on the fixation plate, or possibly the clothing protector plate, so that in the mounted state the fixation plate or the clothing protector plate is clamped between the actual splatter protector element and the wheel protector shackle.

Although it is possible to do without transverse supports of the backrest element for saving weight, the two lateral backrest supports are preferably connected with each other by means of a transverse support, which is bent out at the back. This can simultaneously be used as a handle for pushing the wheelchair by a third person and makes the execution of the just mentioned string pull easier if the transverse rod and the string are grasped with the same hand for pulling the latter upward.

Removable push handles, which are preferably adjustable, for pushing the wheelchair can also be fastened on the upper ends of the backrest supports.

A rigid material or a fabric section could be provided for forming the surface of the backrest, the same as in connection with the seat. In order to obtain an adjustable backrest, which therefore can be adapted to the user of the wheelchair, it is however advantageous to connect the backrest supports by a wide or several narrow longitudinally adjustable flexible pairs of strips, which allows an individual adaptation.

In order to improve the seating comfort, the backrest can furthermore be provided with a backrest cushion Such a backrest cushion preferably has two connected backrest cushion elements, which rest in the front and the back of the connection of the backrest supports and have been inverted from above over the connection of the backrest supports.

So that the backrest cushion remains in place even when the user moves, and so that the backrest cushion is not moved toward the back between the seating surface and the backrest, a textile backrest cushion tab can be attached to the bottom of the front element of the backrest cushion, which comes to rest between the fabric of the seating surface and the seat cushion.

The backrest cushion can also have a pocket in its rear portion.

It is necessary to attach two fabric parts to each other at many places of the novel seat module, wherein these fastenings should preferably be releasable and possibly adjustable in small areas. The seat cushion must be fastened on the seating surface, the two elements of the backrest cushion must be fastened to each other and/or on the elements connecting the backrest supports, and respectively two strips of one of the pairs of strips connecting the backrest supports must be fastened on each other. It has been shown to be advantageous to design all these elements in such a way that Velcro® strips can be used for fastening.

When using the novel seat module in accordance with the invention, it is mounted with its longitudinal seating supports on a frame of a wheelchair.

The seat module is preferably fastened on longitudinal supports of the frame, and the use of the novel seat module is particularly advantageous in connection with a wheelchair in accordance with the invention, which has an integral support, such as described further on above.

For using the novel seat module on a wheelchair whose seat is intended to have an adjustable inclination, the novel seating module can have a seat strut arrangement, such as had been described further on above in respect to the wheelchair in accordance with the invention, with an adjustably inclined seating surface.

For coupling a wheelchair with the front wheel, or respectively the front wheels, lifted, with a bike without there being a danger of backward tilting, the wheel base, i.e. the distance of the front axle of the bike from the pair of rear axles of the wheelchair is increased for example. To this end it is proposed in accordance with the invention to design the rear wheels and their fastening in such a way that the rear wheels can be displaced between a front position, in which they are when used without a bike, and a rear position, in which the wheelchair is less prone to tilting and therefore usable in connection with a bike.

The wheelchair with the U-like integral frame, whose longitudinal supports are connected without struts with the axle tube, is particularly suited for use with a bike. To provide the possibility of increasing the wheel base, the longitudinal supports of such a wheelchair can be extensible in a telescope-like manner in the rear, for example. However, the increase of the wheelbase is preferably achieved in that additional longitudinal supports are fastened to the longitudinal supports, which are connected with each other at the rear by an additional axle tube. When using the wheelchair with a bike, the wheels are then removed from the axle tube and mounted on the additional axle tube. If several fastening spots are provided for the additional longitudinal supports, the wheel base can be selectively changed within defined limits. When the wheelchair is used without a bike, the additional longitudinal supports arranged underneath the seating surface are no bother. For the purpose of improving the tilt resistance, it is of course also possible to increase the wheel base without connecting the wheelchair with a bike, however, in this case a decrease in maneuverability must be accepted.

Further properties and advantages of the invention will be described in what follows by means of a preferred embodiment, making reference to the drawings.

### BRIEF DESCRIPTION OF THE DRAWINGS

FIG. 1 is a diagram of a wheelchair in accordance with the invention with a front wheel support and adjustable inclination of the seat,

FIG. 2A is a simplified representation from the front of the wheelchair in FIG. 1, but without the seat and backrest cushions,

FIG. 2B shows the wheelchair in FIGS. 1 and 2A, in the same representation as in FIG. 2, viewed from the right side; right,

FIG. 3A represents a sectional view along the axle of a first, fixed angle adapter sleeve,

FIG. 3B shows a second fixed angle adapter sleeve in the same representation as in FIG. 3A,

FIG. 4A represents a sectional view along the axle of a first exemplary embodiment of an adjustable angle adapter sleeve in a first position,

FIG. 4B shows the adjustable angle adapter sleeve in FIG. 4A in a second position in the same representations as in FIG. 4A,

FIG. 4C shows a second exemplary embodiment of an adjustable angle adapter sleeve in the same position and representation as in FIG. 4A,

FIG. 4D shows the angle adapter sleeve of FIG. 4C in the same position and representation as the angle adapter sleeve in FIG. 4B,

FIG. 5A is a diagram of a first embodiment of a footrest,

FIG. 5B is a diagram of a second embodiment of a footrest,

FIG. 6 is a diagram of a third embodiment of a footrest,

FIG. 7 is a diagram of a first embodiment of a brake unit,

FIG. 8 is a diagram of a second embodiment of a brake unit,

FIG. 9 is a diagram of a third embodiment of a brake unit,

FIG. 10 is a diagram of a seat module in accordance with the invention for a wheelchair,

FIG. 11 is a diagram of a backrest with a backrest cushion of the seat module in FIG. 10,

FIG. 12A shows a diagram of portions of a first type of a backrest element with push handles,

FIG. 12B shows a diagram of portions of a second type of a backrest element with push handles,

FIG. 12C shows a diagram of portions of a third type of a backrest element with push handles,

FIG. 13 is a diagram of the area of a fixation plate with a clothing protector plate,

FIG. 14 is a diagram of a wheel splatter protector,

FIG. 15 is a diagram of a transit roller device,

FIG. 16 is a diagram of an anti-tilt device,

FIG. 17A represents an additional longitudinal support for use with the wheelchair with a bike, and

FIG. 17B represents a longitudinal support, on which the axle tube can be fastened in different positions, for use with the wheelchair with a bike.

### DETAILED DESCRIPTION OF THE PREFERRED EMBODIMENT

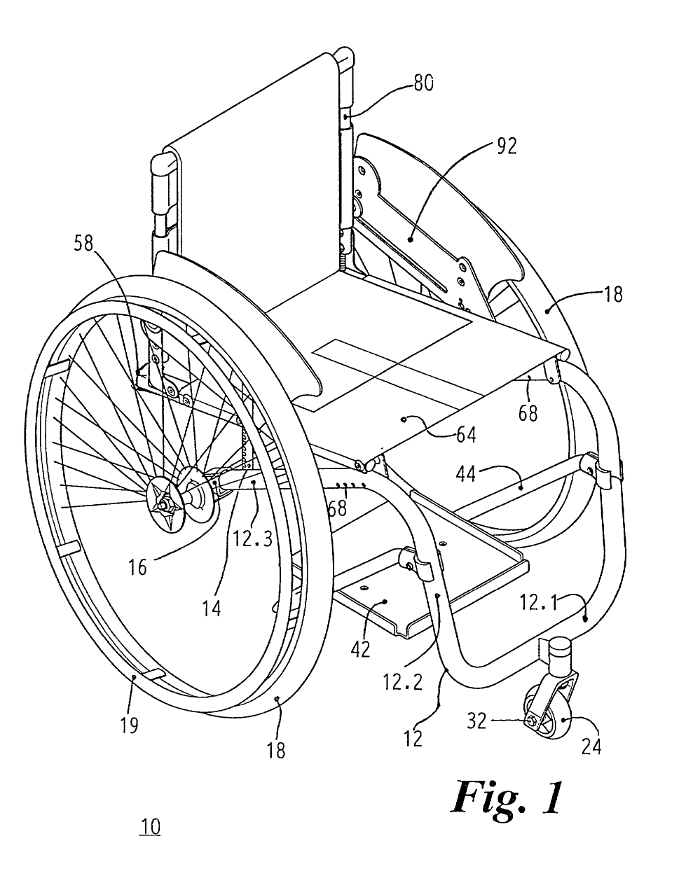

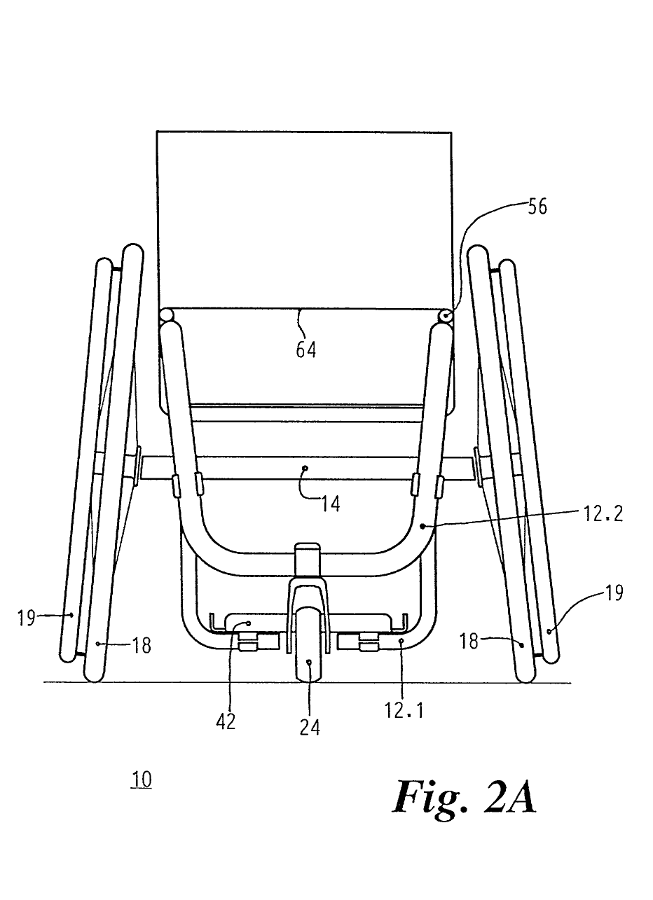

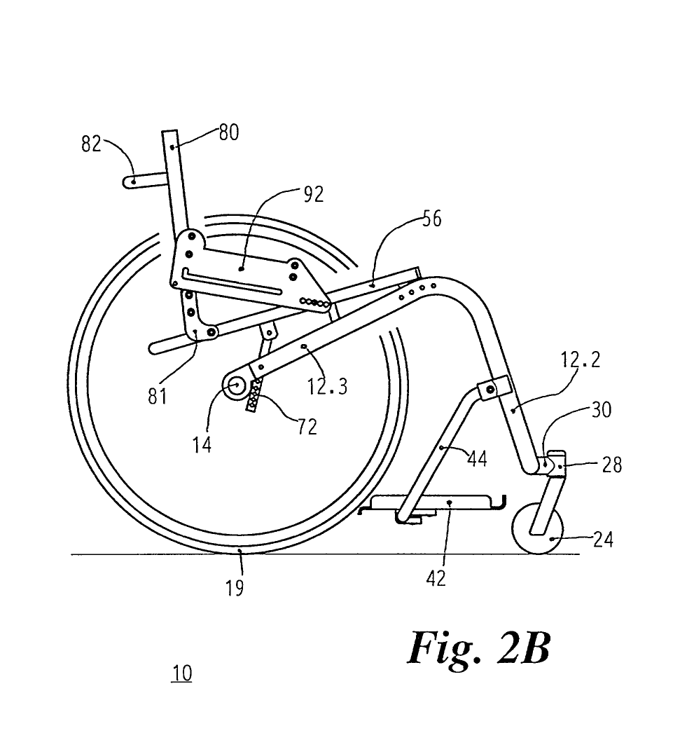

The wheelchair 10 represented in FIGS. 1, 2A and 2B is a three-wheeled wheelchair. It has an integral support 12 with a horizontal front wheel support 12.1 extending transversely to the movement direction, two inclined supports 12.2 adjoining it laterally, which are inclined obliquely to the back and top and slightly toward the outside, and two longitudinal supports 12.3 as their continuation. The integral support 12 is made from a bent tube.

The free rear ends of the longitudinal supports 12.3 of the integral support 12 are connected with each other by means of an axle tube 14, so that the integral support 12 together with the axle tube 14 constitutes a closed and very stable frame. Axle holding devices 16 are used to connect the axle tube 14 with the rear ends of the inclined supports 12.3.

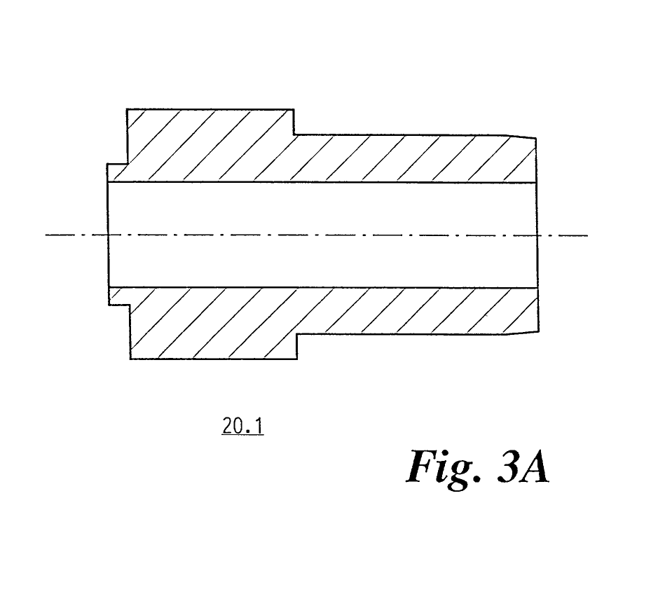

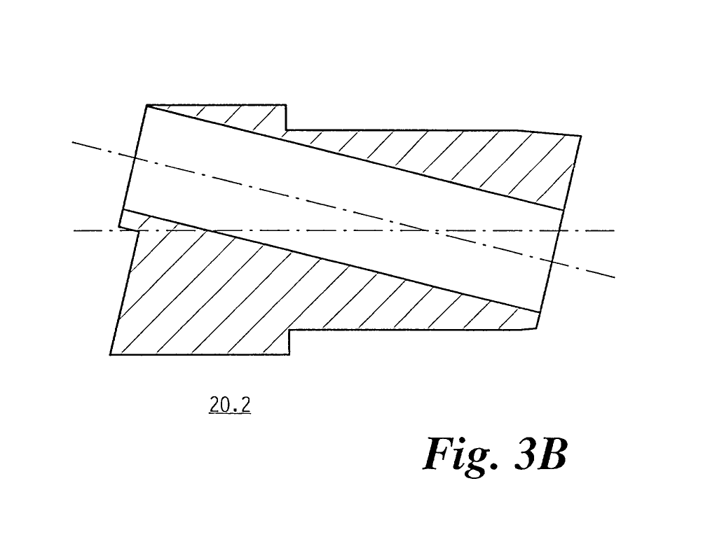

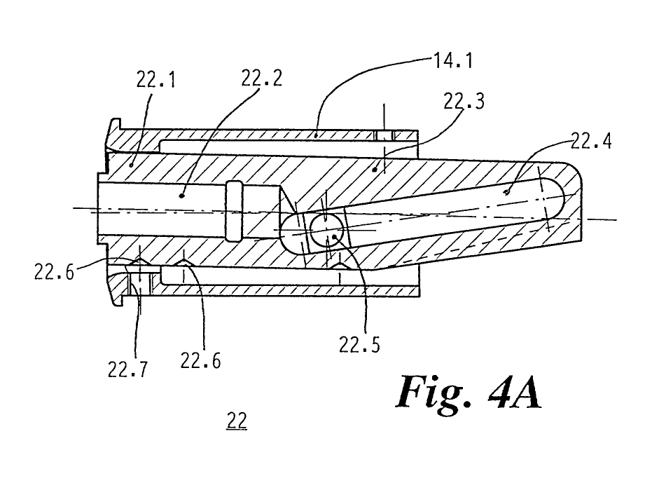

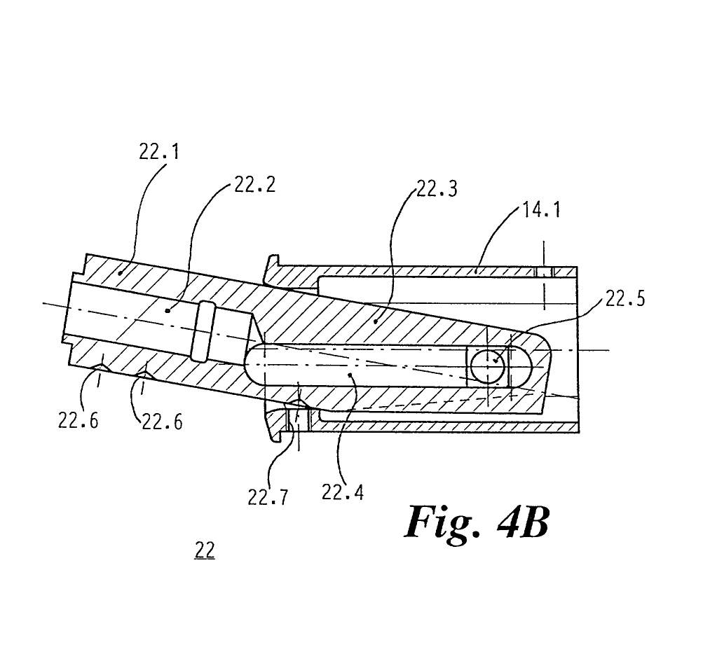

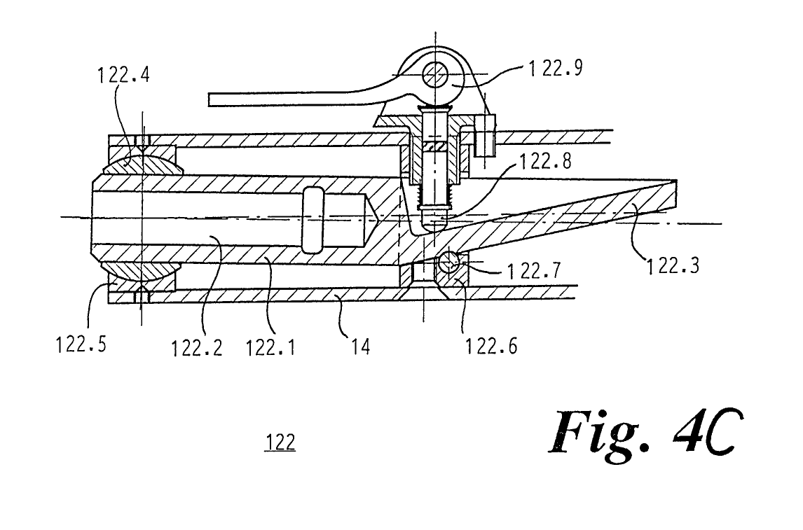

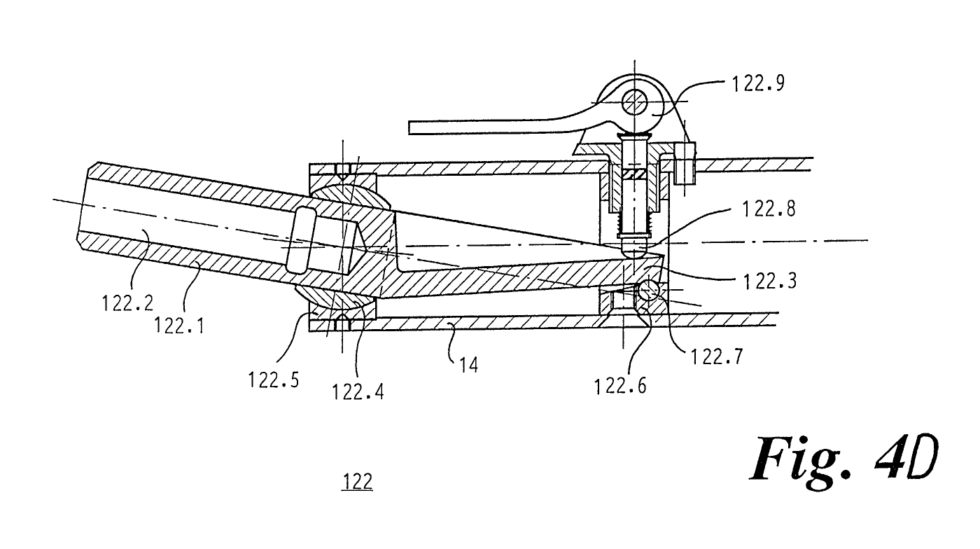

Two rear wheels 18 of a pair of rear wheels are laterally fastened on the axle tube 14 by means of the angle adapter sleeves 20.1, or respectively 20.2, or respectively 22, or respectively 122, represented in FIGS. 3A, 3B, or respectively 4A and 4B, or respectively 4C and 4D. Each angle adapter sleeve 20.1, or respectively 20.2, or respectively 22, or respectively 122, which is pressed with a portion of its length into one of the open ends of the axle tube 14 and projects out of the axle tube 14 with its remaining length, constitutes a seating for a full floating axle, not represented, by means of which a rear wheel 18 is fastened. To change the wheel camber, it is either necessary to exchange the angle adapter sleeve 20.1 in accordance with FIG. 3A for an angle adapter sleeve 20.2 in accordance with FIG. 3B, which has been made for a different camber, or an adjustable angle adapter sleeve 22 in accordance with FIG. 4A and FIG. 4B, or an adjustable angle adapter sleeve 122 in accordance with FIG. 4C and FIG. 4D may be used. It is expressly pointed out that the adjustable angle adaptable sleeves in accordance with FIGS. 4A, 4B or 4C, 4D can be used in connection with practically all wheelchairs, not only in connection with the above described wheelchair with an integral frame.

The angle adapter sleeve represented in FIG. 3A results in a minimum camber of 0°, and the angle adapter sleeve represented in FIG. 3B results in a camber in the range of a maximum value of approximately 15° used in the construction of the instant angle adapter sleeve.

FIGS. 4A and 4B show an adjustable angle adapter sleeve 22 in two different settings, wherein with the setting in accordance with FIG. 4A the camber is 1°, and 10° with the setting in accordance with FIG. 4B. The angle adapter sleeve 22 has a cylindrical element 22.1 with a seating bore 22.2 and an asymmetrically tapering element 22.3, wherein the cylindrical element 22.1 is received as a function of the camber, and the asymmetrically tapering element 22.3 is always received in the end of the axle tube 14, or respectively in a connecting sleeve 14.1 to the axle tube 14. The asymmetrically tapering element 22.3 has a slit-like opening 22.4 and can perform a longitudinal/tilt motion, wherein it is guided in the slit-like opening 22.4 by means of a guide pin 22.5 fixed in place on an intermediate sleeve 14.1 of the axle tube 14. The cylindrical element 22.1 has several cutouts 22.6 on its circumference. Depending on the position of the angle adapter sleeve 22, a fixation screw, not represented, screwed into a thread 22.7 provided on the intermediate sleeve 14.1, engages one of the cutouts 22.6. The adjustable angle adapter sleeves can be employed in connection with any arbitrary wheelchair type, the same as the exchangeable adapter sleeves.

FIGS. 4C and 4D show a further adjustable adapter sleeve 122 in two different settings, wherein with the setting in accordance with FIG. 4C the camber is approximately 1°, and approximately 10° with the setting in accordance with FIG. 4D. The angle adapter sleeve 122 has a cylindrical element 122.1 with a seating bore 122.2 and an asymmetric shoulder 122.3, oriented obliquely towards the axis of the seating bore 122.2. The cylindrical element 122.1 extends through a bearing cylinder 122.4, which is rotatably seated via an axle tube insertion element 122.5 in the rear transverse support, or respectively the axle tube 14. The asymmetric shoulder 122.3 is supported via a further axle tube insertion element 122.6 and a transverse shaft 122.7 in the rear transverse support, or respectively the axle tube 14. In the mounted position, a plunger 122.8, which can be actuated via an eccentric lever 122.9, presses the asymmetric shoulder 122.3 downward against the force of a spring. By means of pivoting of the eccentric lever 122.9, the plunger 122.8 moves away from the asymetric shoulder 122.3 under the force of the spring, so that the angle adapter sleeve 122 can be put in another position, and is fixed in place in this new position by a renewed turning of the eccentric lever 122.9.

So that the track of the rear wheels 18 runs parallel with the movement direction, or respectively longitudinal center axis of the wheelchair 10, the axle tube 14 with the angle adapter sleeves 20.1, 20.2, or respectively 22, or respectively 122, must be adjusted in such a way that the bearings, and therefore the full floating axles, not represented, of the rear wheels 18, which must be oriented toward the outside slightly upwardly in accordance with the desired camber, must be located exactly in a transverse plane in respect to the longitudinal center axis of the wheelchair 10. A spirit level, not represented, has been provided on the axle tube 14 for adjusting the angle adapter sleeves, or respectively the axle tube 14.

The rear wheels 18 can be manually propelled in the customary manner by means of grip rings 19 which are fastened on them and are concentric in respect to them.

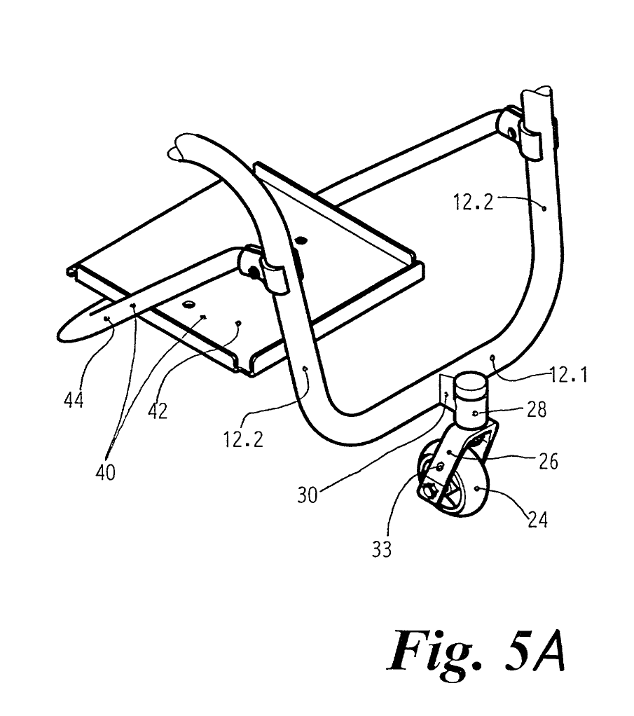

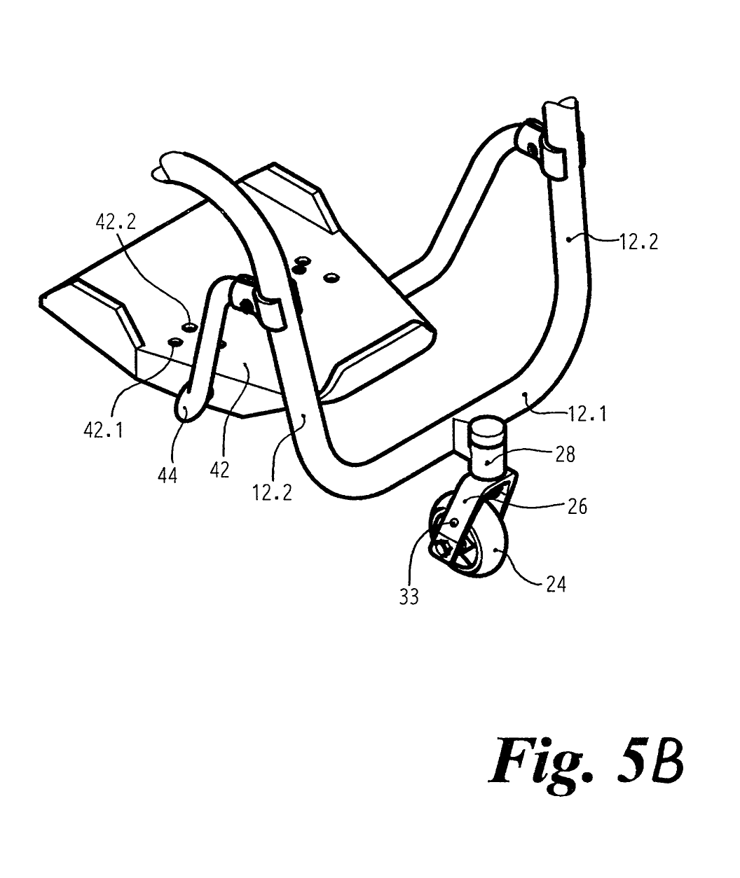

In accordance with FIGS. 5A and 5B, the front wheel arrangement has a non-driven front wheel 24. whose diameter is considerably smaller than the diameter of the rear wheels 18. The front wheel 24 is seated in a fork 26. On its upper end, the fork 26 has a vertical pivot pin, which is rotatably received in a pin bearing 28, which is fastened via a shoulder 30 on the front wheel support 12.1. The shoulder 30, and therefore also the pin bearing 28, are mounted on the front of the front wheel support 12.1 of the integral support 12, so that the pivot pin is located ahead of the front wheel support 12.1 embodied as a transverse support. For receiving a front wheel axle 32, the two ends of the fork 26 have pairs of bores 33 at two or more levels, so that the front wheel 24 can be installed at different heights, by means of which the inclination of the entire wheelchair 10 can be changed. A further possibility for changing the inclination of the entire wheelchair 10 is provided by installing smaller or larger front wheels 24. In place of the one, centrally arranged front wheel support, the front wheel arrangement can also have a pair of front wheels, which are symmetrically fastened on the integral frame.

FIGS. 5A and 5B represent the front wheel support 12.1 with a footrest 40 arranged behind the front wheel support 12.1 and between the inclined support 12.2. It essentially consists of a first footrest plate 42, which is slightly differently designed in the two embodiments in accordance with FIG. 5A on the one hand and FIG. 5B on the other. The footrest plate 42 in accordance with FIG. 5B is slightly less bulky than the footrest plate 42 in accordance with FIG. 5A, but permits less freedom in positioning the feet of the user. In addition, the footrest plate 42 in accordance with FIG. 5B has openings 42.1 for ventilation and the run-off of rainwater, and/or protrusions 42.2, by means of which sliding of the feet of the user can be prevented. The footrest plate 42 is used for supporting the feet of the user and is fastened on the inclined supports 12.2 of the integral support 12 by means of two lateral footrest struts 44. The footrest 40 can be mounted at different heights, and the inclination of the footrest plate 42 is adjustable.

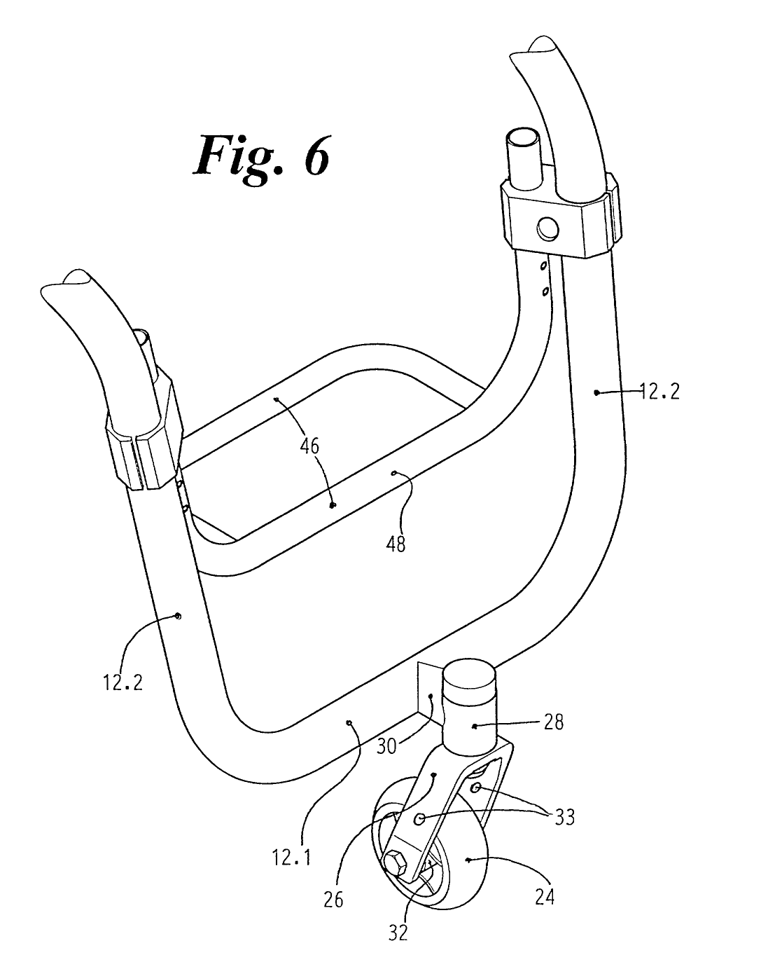

Another footrest 46 is represented in FIG. 6, which has a stirrup device 48 for placement of the feet and is superior to the one in FIG. 5 in respect to height adjustability of the footrest plate 40 in connection with short lower legs.

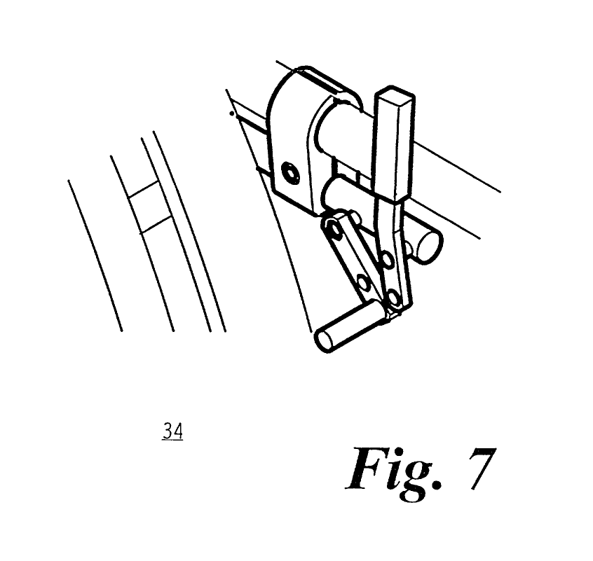

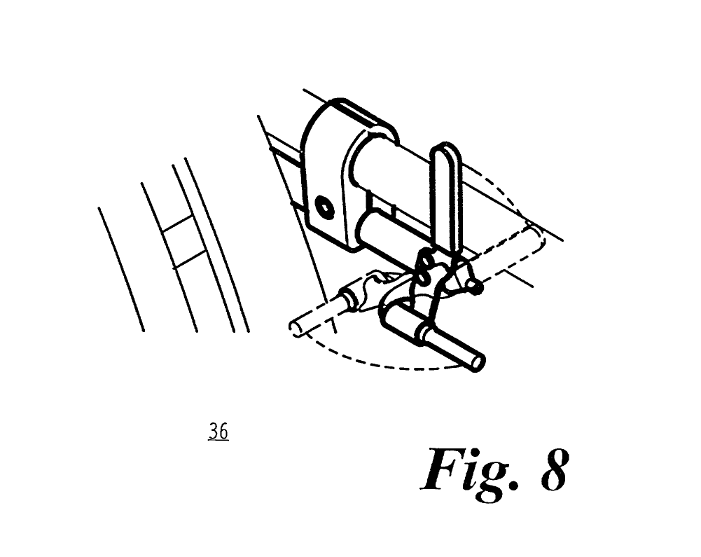

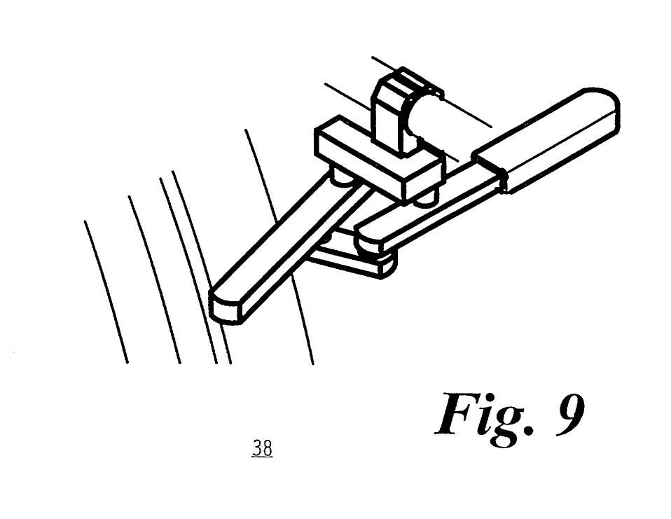

The wheelchair 10 furthermore has a brake device formed by two brake units. The brake units are embodied to be diametrically opposed and mounted mirror-reversed in the front area of the longitudinal supports 12.3. FIGS. 7 to 9 show three different embodiments, known per se, of a brake unit 34, or respectively 36, or respectively 38, and do not require further explanations.

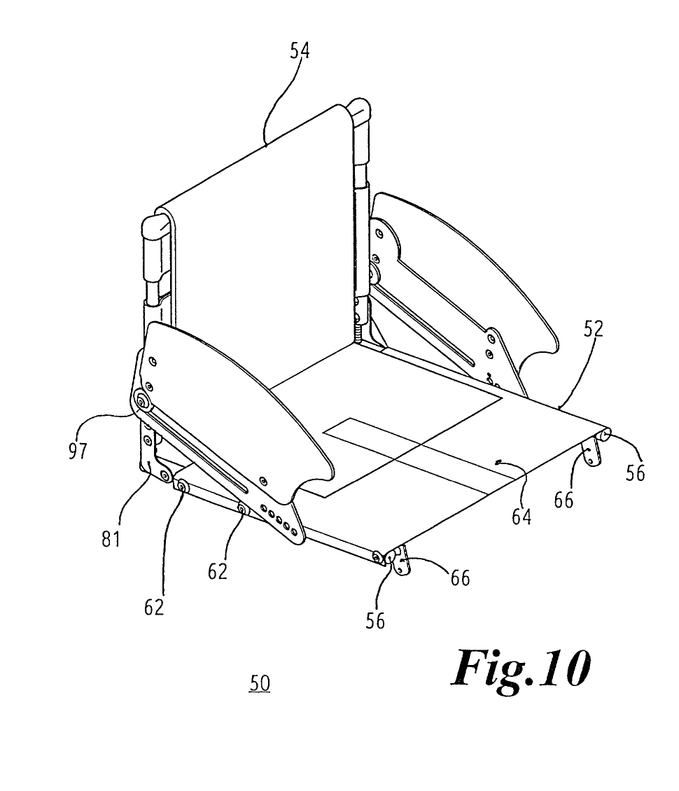

A seat module 50 in accordance with the invention is represented in FIG. 10. This seat module 50 essentially consists of a seat 52 and of a backrest 54.

The seat 52 has two parallel longitudinal seat supports 56 which, together with a rear transverse seat support 58 in accordance with FIG. 1, form a U-shaped seat frame made of an appropriately bent tube, which is reinforced by means of a further, downwardly arched transverse seat support 60, not visible in the drawings. A section of textile material is fastened between the longitudinal seat supports 56 by means of several screws 62, and essentially constitutes the seating surface 64, on which a seat cushion, not represented, is arranged.

On its front end each longitudinal seat support 56 has a shoulder with a fastening tab 66, which contains bores intended for receiving a screw, by means of which the front end of the longitudinal seat support 56 is fastened in one of several bores 68, visible in FIG. 1, on the front end of the longitudinal support 12.3 of the integral support 12 of the wheelchair 10.

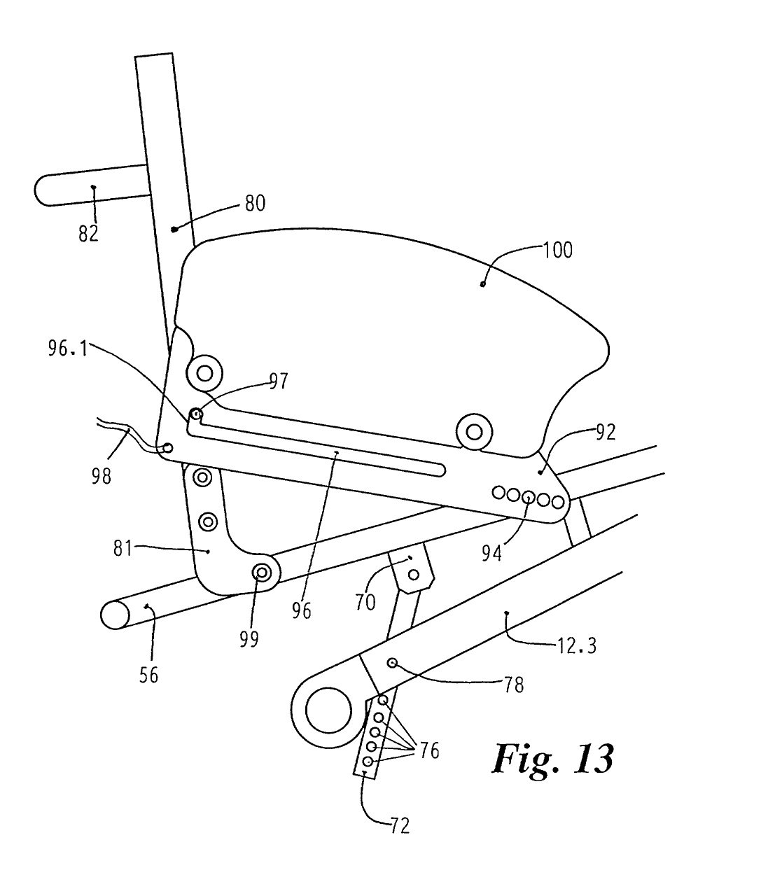

As can best be seen in FIG. 13, respectively one further shoulder with a further fastening tab 70 is provided on both longitudinal seat supports 56 in the rear area of the actual seating surface 64. These fastening tabs are used for respectively hingeing a seat strut 72. The two seat struts 72 constitute a seat strut pair and are arranged parallel by means of a transverse rod arrangement, not represented, which connects them. Each seat strut 72 has a plurality of bores 76, which are provided for receiving a screw 78, by means of which the seat strut 72 is fastened on the rear end of the associated longitudinal support 12.3 of the integral support 12. The effective lengths of the seat struts 72, and thus the angle of inclination of the seating surface 64 is determined by the respective selection of the bore 76 for the screw 78, wherein the maximum inclination of the seating surface 64 is slightly less than the inclination of the longitudinal supports 12.3.

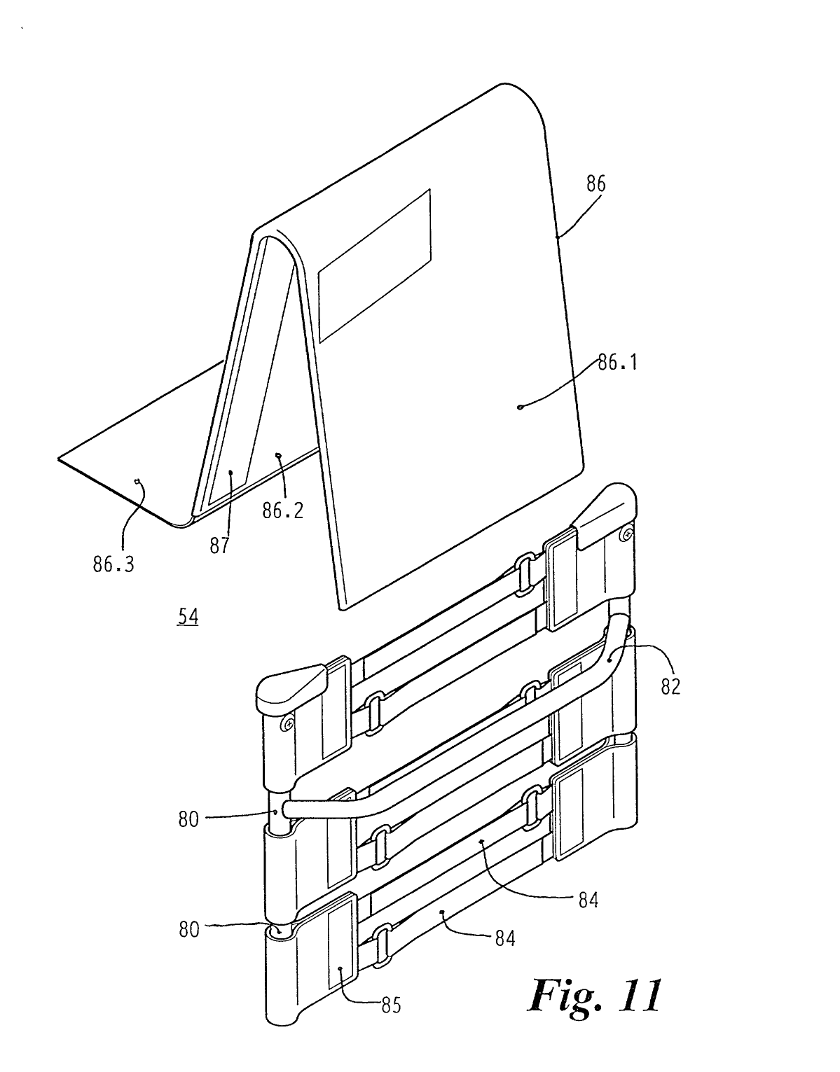

The backrest 54 has two lateral backrest supports 80, which are fastened by means of angle plates on the longitudinal seat supports 56, wherein the angle between the backrest 54 and the seating surface 64 is adjustable. The two backrest supports 80 are connected with each other by means of a rearward arched transverse rod 82. In accordance with FIG. 11, pairs of strips 84 extend between the backrest supports at several levels, whose length is adjustable and which are partially equipped with Velcro® strips 85.

The backrest 54 furthermore has a back cushion 86 with as rear cushion element 86.1, a front cushion element 86.2 and a back cushion flap 86.3, which is fastened on the lower end of the front cushion element 86.2 and in the assembled state rests between the seating surface 64 and the seat cushion. The back cushion 86, like the pairs of strips 84, is also corresponding equipped with Velcro(R) strips 87.

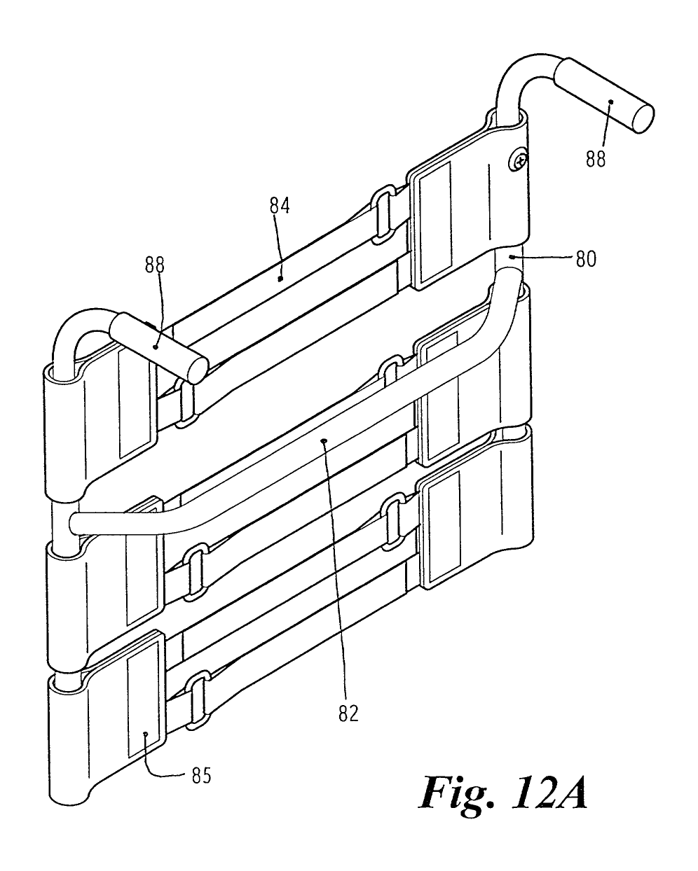

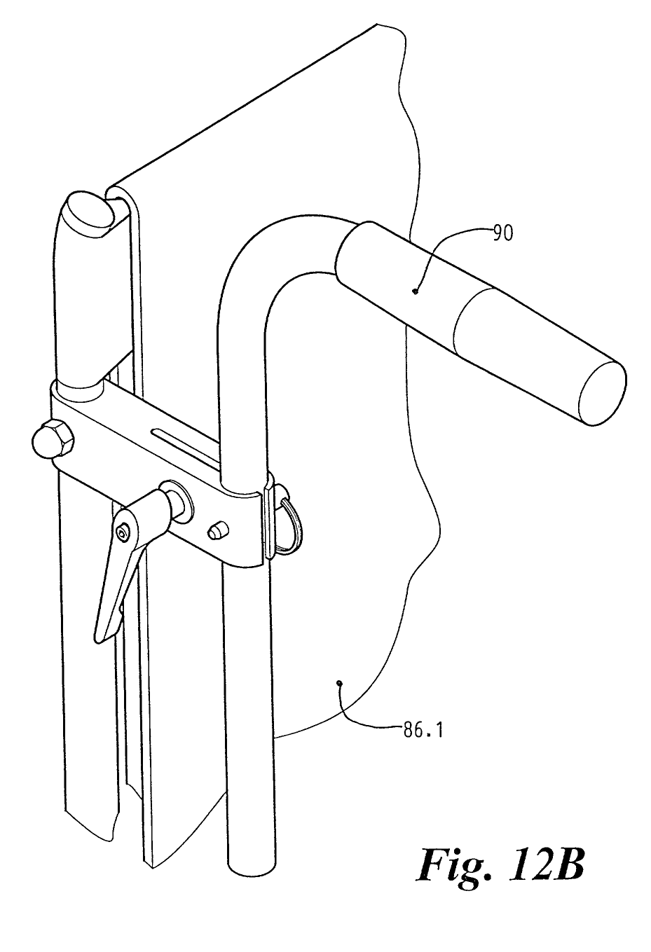

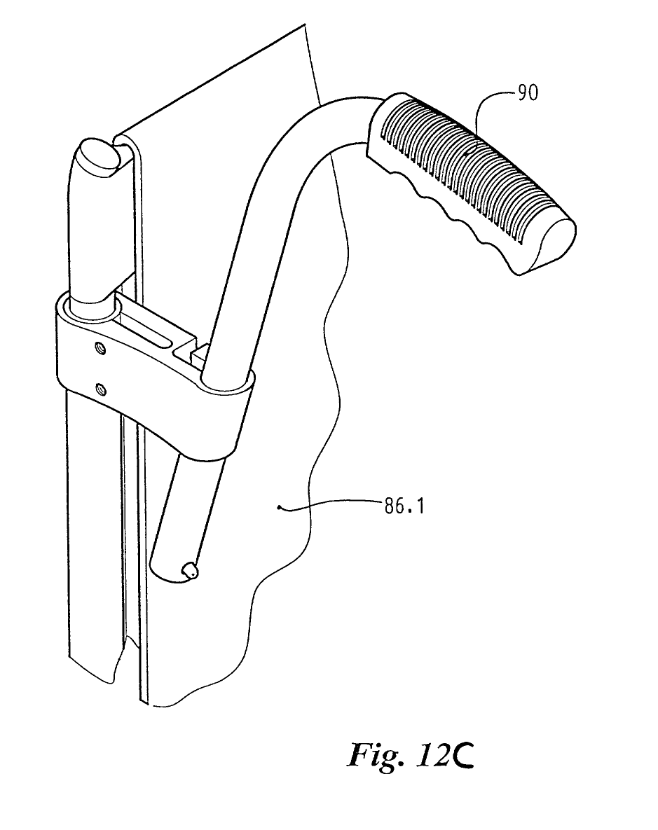

Either the transverse rod 82 in accordance with FIG. 11 or handles 88 in accordance with FIG. 12A or height-adjustable handles 90 in accordance with FIG. 12B or FIG. 12C are used for pushing the wheelchair 10.

Again making reference to FIG. 13, the constructive steps which were performed with the seat module 50 for making possible the folding of the backrest 54 on the seat 52 will now be described. With its front end, a fixation plate 92 is pivotably fastened at 94 on the longitudinal seat support 56, wherein several bores permit mounting in different positions, which determine the relative inclination of the backrest 54 in respect to the seating surface 64. The fixation plate 92 furthermore has a slit-shaped opening 96, into which a pin 97 fastened on the backrest support 80 projects. At its rear end the opening 96 is widened upward and forms a detent opening 96.1 for the pin 97 when the backrest 54 is folded upward. To fold the backrest 54 down, an upward pull is exerted on a string 98, which connects the rear ends of the fixation plates 92. Because of this, the pin 97 comes free of the detent opening 96.1 and the backrest 54 can be inclined forward while the pin 97 is displaced in the opening 96. The screw 99 connecting the backrest 54 with the longitudinal seat support 56 is not tightened, but is used as a pivot shaft during the folding movement of the backrest 54.

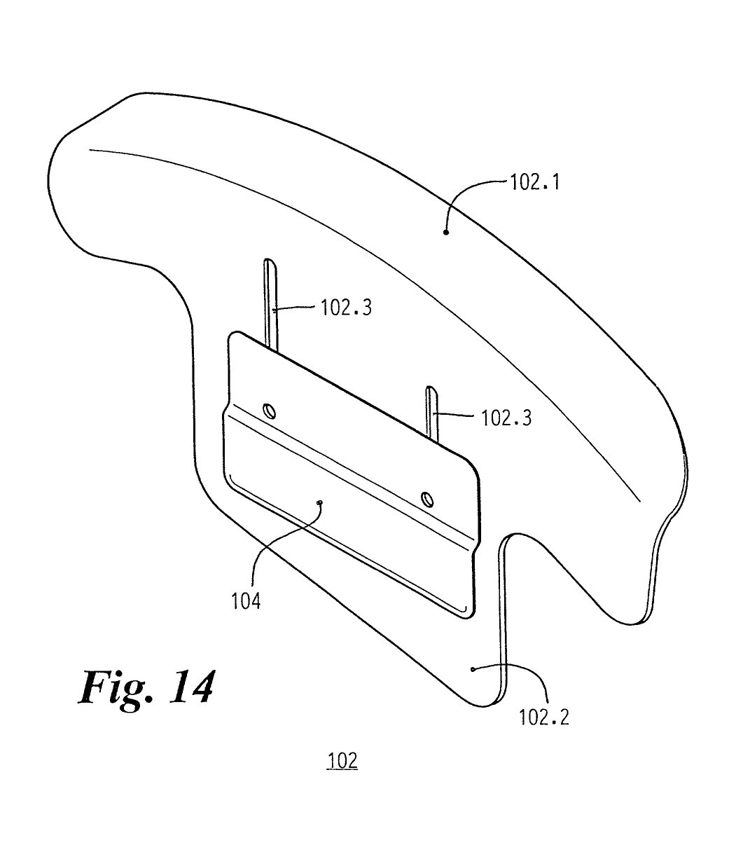

The fixation plate 92 is also used as a mounting plate for a screwed-on clothing protector plate 100 in accordance with FIG. 13, or a wheel splatter protector 102, which can be slipped on and is represented in FIG. 14. The wheel splatter protector 102 has an element 102.1, bent toward the wheel, and a vertical element 102.2. A slip-on shackle 104 is screwed to the latter, wherein not bores, but slits 102.3 are provided on the vertical part for the screws, not represented. By means of this the slip-on shackle 104 can be screwed in place in different positions, because of which the wheel splatter protector 102 can take up different positions in respect to the fixation plate 92.

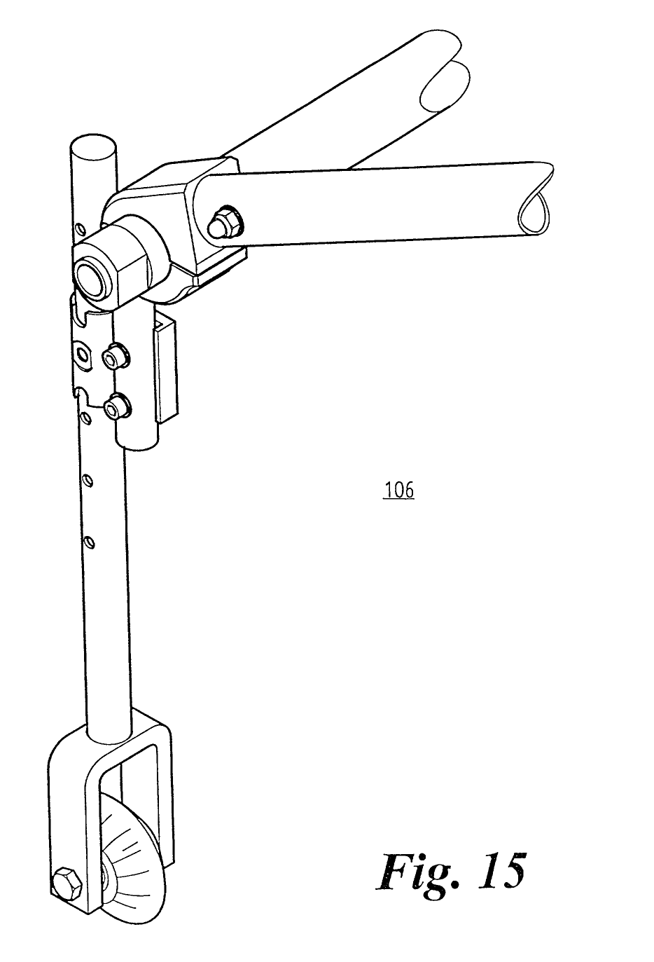

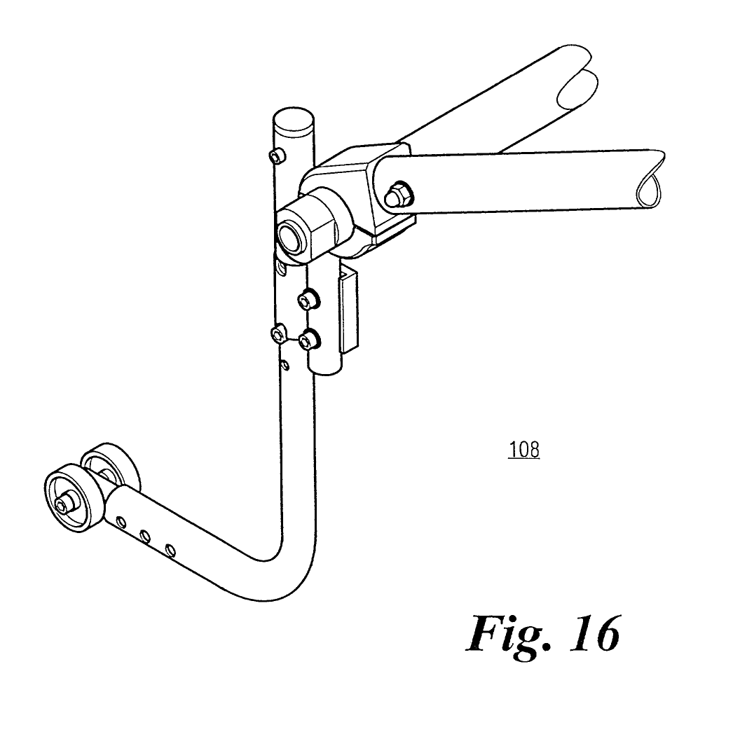

If required, the wheelchair 10 can be equipped with a transit roller device 106 in accordance with FIG. 15 and/or with an anti-tilt device 108 in accordance with FIG. 16.

FIG. 15 represents a transit roller device and FIG. 16 an anti-tilt device, which can be optionally arranged on the wheelchair 10.

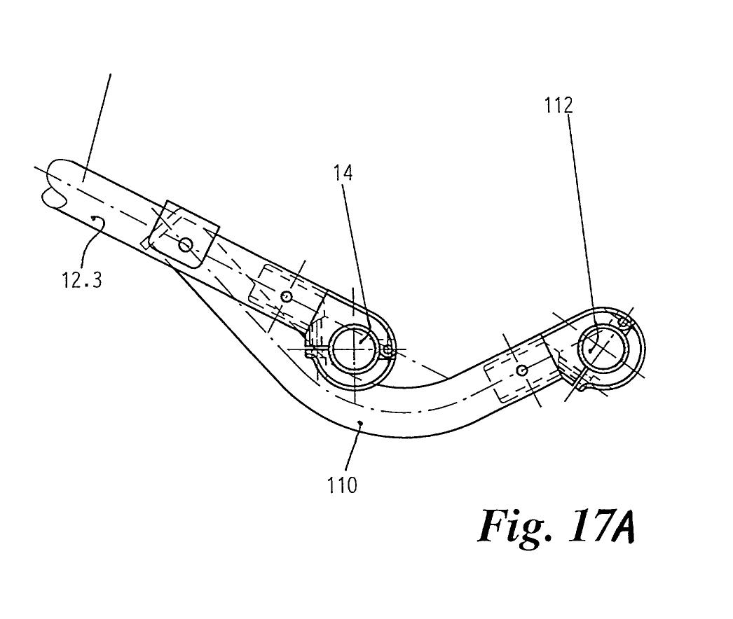

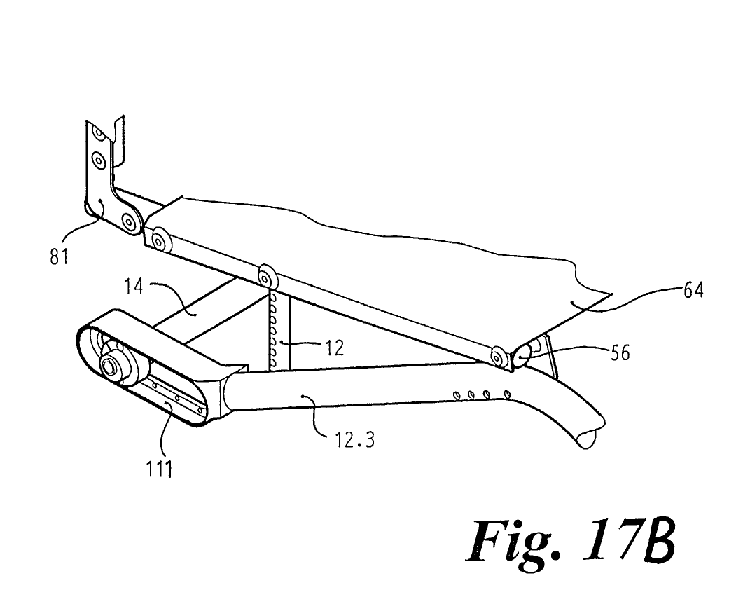

An additional longitudinal support 110 with an additional tube 112 are represented in FIG. 17A. This additional longitudinal support 110 is fastened on a frame element 12.3 of the wheelchair, if the latter is intend to be temporarily used with a bike. In the illustrated exemplary embodiment, the frame element 12.3, on which the additional longitudinal support 110 is fastened, is the longitudinal support, which is inclined backward and downward and is connected without struts with the axle tube 14, of the U-like integral support 12 as represented in FIGS. 1 to 3.

An embodiment variant of the wheelchair 10 is represented in FIG. 17B, wherein the frame element 12.3 has a rearward projecting extension 111 on its rear end. Such an embodiment is selected in order to be able to vary the wheel base, i.e. the mutual distance from each other of the rear wheels 18 on the one hand and the front wheels 24 on the other hand, for example for users whose legs have been amputated, or for being able to use the wheelchair 10 temporarily with a bike.

What is claimed is:

1. A wheelchair with a front wheel support which is at least approximately horizontal and has a fastening device for a front wheel assembly, with two lateral longitudinal supports and with two inclined supports which connect the front wheel support with the front ends of the longitudinal supports, and with an axle tube connecting two rear wheels of a pair of wheels,
characterized in that
the front wheel support is a transverse support and forms, together with the inclined supports and the longitudinal supports adjoining them, a three-dimensional, U-like integral support, wherein the rear ends of the longitudinal supports are connected with the axle tube.

2. The wheelchair in accordance with claim 1,
characterized in that
the front wheel assembly has a single, centered front wheel

3. The wheelchair in accordance with at least one of the above claims,
characterized in that
the rear wheels are seated by means of full floating axles in adjustable angle adapter sleeves, which are connected with the axle tube.

4. The wheelchair in accordance with at least one of the above claims,
characterized in that
the longitudinal supports of the integral support are inclined toward the rear and downward, and are connected without struts with the axle tube.

5. The wheelchair in accordance with at least one of the above claims,
characterized in that
it has a footrest, which is arranged back of the front wheel support and preferably is height-adjustable and/or inclination-adjustable.

6. A wheelchair with an adjustably inclined seat, which has two lateral longitudinal seat supports, which are fastened on the longitudinal supports of the wheelchair,
characterized in that
the longitudinal supports are inclined toward the rear and downward, and that the longitudinal seat supports are hinged with their ends on the longitudinal supports, and are connected by their other ends via seat struts of variable effective lengths with the longitudinal supports.

7. The wheelchair in accordance with claim 6,
characterized in that
each seat strut is pivotably hinged on the associated lateral longitudinal support and has several bores in the longitudinal direction for the selective reception of a screw, by means of which the seat strut is fastened on the longitudinal support.

8. The wheelchair in accordance with at least one of claims 6 to 7,
characterized in that
the seat struts are connected with each other by means of a transverse rod arrangement.

9. A wheelchair with variably inclined rear wheel axles, wherein each rear wheel axle is arranged on a lateral end section of an axle tube,
characterized in that
an adjustable adapter sleeve is arranged in the lateral end section of the axle tube, which comprises a bore intended for receiving a full floating axle and a detent surface, which is oriented obliquely in respect to the axis of the end area of the axle tube and which can be longitudinally displaced in the end area of the axle tube, wherein a fixation device is provided in order to selectively fix the adapter sleeve in place in one of several positions.

10. A seat module for a wheelchair, comprising a seat and a backrest,
characterized in that
the seat can be fastened to at least one frame element of the wheelchair, and that the backrest is indirectly fastened via the seat to the frame element of the wheelchair, wherein the angle between the seat and the backrest preferably is adjustable.

11. The seat module in accordance with claim 10,
characterized in that
the seat has two lateral longitudinal seat supports, between which a seating surface is arranged.

12. The seat module in accordance with claim 10,
characterized in that
the seat has at least one transverse seat support, which connects the longitudinal seat supports.

13. The seat module in accordance with at least one of claims 10 to 12,
characterized in that
the seatback has two lateral seatback supports.

14. The seat module in accordance with claim 13,
characterized in that
the backrest supports are connected with each other, preferably by at least one longitudinally adjustable pair of strips.

15. The seat module in accordance with at least one of claims 10 to 14,
characterized in that
it has a back cushion with a rear back cushion element, a front rear cushion element intended to rest against the back of the user, and a back cushion flap, which is preferably fastened on the front back cushion element and lies between the seating surface and a seat cushion arranged on the seating surface.

16. The seat module in accordance with at least one of claims 10 to 15,
characterized in that
the backrest can be folded down on the seat.

17. The seat module in accordance with claim 16,
characterized in that
it comprises two lateral fixation plates, each one of which is hinged by its front end to the associated longitudinal seat support and has an elongated opening, into which a pin, which is fastened on the associated backrest support, projects.

18. The seat module in accordance with claim 17,
characterized in that
on each side it has a clothing protector plate and/or a wheel splatter protector, which are preferably fastened on the fixation plate.

19. Use of the seat module in accordance with at least one of claims 11 to 17,
characterized in that
the lateral longitudinal supports are fastened on a frame of the wheelchair, preferably on the longitudinal supports.

20. Use in accordance with claim 19,
characterized in that
in a first transverse plane the seat module is connected directly, and in a second transverse plane via seat struts, whose effective length can be adjusted, with the longitudinal supports, which are inclined in the longitudinal direction of the wheelchair.

21. Use of a wheelchair in connection with a bike,
characterized in that
the wheel base of the wheelchair is adjustable, preferably in that the rear wheels can be adjusted between a front position, suitable for use with the wheelchair, and a rear position, suitable for use with a bike.

22. Use in accordance with claim 21,
characterized in that
longitudinal supports of the wheelchair, on which the rear wheels are fastened, can be extended.

23. Use in accordance with claim 22,
characterized in that
the longitudinal supports of the wheelchair are extended by means of additional longitudinal supports mounted on them, on which the rear wheels are fastened by means of an additional axle tube.

24. Use in accordance with claim 22,
characterized in that
the longitudinal supports of the wheelchair preferably have integral extensions at the rear, on which the axle tube can be mounted in different positions.
